(19) United States
(12) Patent Application Publication
(10) Pub. No.: US 2021/0362002 A1
(43) Pub. Date: Nov. 25, 2021

(54) EXERCISE AND REHABILITATION APPARATUS

(71) Applicant: EA CERHYS PTY LTD, Highland Valley (AU)

(72) Inventor: Erik BUCHIW, Highland Valley (AU)

(73) Assignee: EA CERHYS PTY LTD, Highland Valley (AU)

(21) Appl. No.: 17/272,728

(22) PCT Filed: Aug. 19, 2019
(86) PCT No.: PCT/AU2019/050869

§ 371 Date: Mar. 2, 2021

(30) Foreign Application Priority Data
Sep. 18, 2018 (AU) 2018903507

(51) Int. Cl. A63B 23/04; A63B 23/12; A63B 21/012; A63B 21/00

(52) U.S. Cl. CPC A63B 23/0494; A63B 21/00069; A63B 21/0125; A63B 23/12

(57) ABSTRACT

There is proposed an apparatus for joint exercise and rehabilitation. The apparatus including a housing which supports a plurality of spaced apart motion devices that enable a user to position a limb thereon or onto a platform supported thereon, such that the limb is movable along a generally arcuate path to undertake a joint exercise and/or rehabilitation activity of the limb or joint.

### FIELD OF THE INVENTION

The present disclosure relates generally to a joint or limb rehabilitation apparatus and in particular to a leg exercise and/or knee rehabilitation apparatus.

### BACKGROUND OF THE INVENTION

Movement of joints in the human body, such as knee joints, and surrounding tissue may be adversely affected by injury, disease, surgery and age. Common joint injuries include ligament, tendon and cartilage tears, and patello-femoral pain syndrome. In such situations it may be necessary to undertake rehabilitation exercises to increase movement or prevent further degradation of the joint. Furthermore, the elderly and patients in convalescence commonly suffer from poor muscle tone in their limbs, which reduces mobility and can lead to further injury, such as due to falls, or poor health outcomes due to a lack of adequate exercise.

After knee replacement or arthroplasty surgery, where the weight-bearing surface of a knee joint are replaced to relieve pain, it is necessary for a patient to engage in rehabilitation exercises to inhibit scar tissue from forming around the knee joint. These rehabilitation exercises must be started within a short period of time after the surgery to speed up recovery, reduce postoperative pain and inhibit the formation of scar tissue around the joint, which may also reduce limb mobility in the future.

Common forms of rehabilitation exercises include knee straightening exercises, bed-supported knee bends and sitting supported knee bends. To assist in these exercises a patient may place their foot on a skateboard, ball or plastic bag to reduce friction. However, these devices are only of limited assistance and the knee's axis of rotation is constantly moved up and down which may exacerbate pain in the joint.

There are a number of devices suggested in the published prior art that are used to assist in knee rehabilitation to improve limb mobility. One system is disclosed in US Patent Application 20070149368 (KOCH) entitled Knee rehabilitation device. KOCH teaches a device for knee rehabilitation consisting of a foot support wherein the device is actuated manually by pulling the foot towards the knee using a leash, to improve the range of motion after knee injury or surgery. However, the leg is not supported during the exercise, which may increase pain in the knee joint.

Another simple device for rehabilitation in disclosed in US Patent Application 2011224585 (HALL), that can be used during various stages of knee rehabilitation without requiring assistance. However, the foot of the user is not always supported which means that movement may be difficult or increase pain for some users. U.S. Pat. No. 7,695,416 (WEINER) entitled Device and method for knee joint rehabilitation, provides a large complex apparatus, wherein a patient must be seated on the apparatus to undertake the exercises. Another relatively complex system is disclosed in European Patent Application EP25836656 (Csernatony) which provides a continuous passive motion device for knee rehabilitation, which is configured to hold the patient's foot and causes leg movement in the vertical plane.

There are however limitations with the prior art, in that they do not support the leg whilst undertaking the rehabilitation exercises or are large expensive apparatus that would not be suitable for use outside of a clinic or hospital setting.

The term ‘knee’ used throughout the specification should be understood to relate to the movement of a user's leg around the knee joint and includes the rehabilitation of movement of the knee region in general, including the ligaments, muscles and skin thereof. Furthermore, the present invention can be used on the rehabilitation or exercise of any joint, such as, but not limited to the knee, ankle, hip elbow, wrist or shoulder. The terms roller/s or slider/s or bearing/s used throughout the specification should be giving their broadest definition and the phrase motion devices should be defined as any device that is able to allow movement or be moved, to thereby reduce friction as the limb is moved along an arcuate path.

It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

### SUMMARY OF THE INVENTION

It is therefore an object of the illustrated embodiments to provide for an apparatus for assisting in undertaking exercise of a limb or joint and/or rehabilitation exercise of the limb or joint. Other objects of the illustrated embodiments are to overcome at least some of the aforementioned problems, or at least provide the public with a useful alternative. The foregoing objects should not necessarily be considered as cumulative and various aspects of the invention may fulfil one or more of the above objects.

The invention could be broadly understood to comprise an apparatus including, a housing which supports a plurality of spaced apart motion devices that enable a user to position a limb thereon or adjacent thereto, such that the limb is movable along a generally arcuate path to undertake joint exercise and/or rehabilitation exercise of the limb or a joint thereof.

In one aspect of the invention, but not necessarily the broadest or only aspect there is proposed a limb or joint exercise and/or rehabilitation apparatus, comprising,

a generally elongate base,
a first wall portion extending upwardly from the base,
a second wall portion extending upwardly from the base, and spaced apart from the first wall portion, and
a plurality of spaced apart motion devices, intermediate of the first wall portion and second wall portion, and forming or following a generally arcuate path, wherein a part of a user's limb is supportable on at least some of the motion devices, or on a platform supported thereon or attached thereto, to permit a user to undertake exercise and/or rehabilitation activities of the limb or a joint thereof, by way of movement of the part of the user's limb along the arcuate path, thereby enabling flexion and extension of the joint of the user.

In one form the apparatus can be used as a leg exercise and/or knee or hip rehabilitation apparatus, wherein the apparatus is placed on the floor surface and the user's foot is placed on at least some of the motion devices or on the platform supported thereon, to undertake the exercise and/or rehabilitation activities.

In another form the apparatus can be used as an arm exercise and/or elbow or shoulder rehabilitation apparatus, wherein the apparatus is placed on a raised surface, such as a table, and the user's hand or forearm is placed on at least some of the motion devices or on the platform supported thereon, to undertake the exercise and/or rehabilitation activities.

The apparatus may be used for the exercise and/or rehabilitation of the muscles, tendons, joins and/or ligaments of the leg, knee, ankle, wrist, elbow, and/or shoulder.

In one form the motion devices are spaced apart rollers, sliders or bearings that engage respective arcuate grooves or shoulders in, or on, inner sides of the first and second side walls, wherein the rollers or sliders are configured to follow the generally arcuate path delineated by the arcuate grooves.

The platform in one form may comprise a generally planar body, having an upper surface including or comprising a grip surface, and depending flanges on opposite sides of the body. Each of the depending flanges includes at least two rollers, slide members or bearings that extending sidewardly therefore such that the at least two rollers, slide members or bearings engage respective arcuate grooves in the first or second wall portions. In this way the platform is movable along the arcuate path delineated by the arcuate grooves to permit the user to undertake joint rehabilitation and/or exercise.

Alternatively, the platform can be supported on the plurality of spaced apart rollers or bearings that are rotatably connected to the first and second wall portions along the generally arcuate path.

The platform may be flexible and/or the rollers/sliders may be located along a flexible track or tracks that conform to the arcuate grooves.

Accordingly, whether the fixed rollers or movable rollers/sliders/bearings are used the patient or user is able to undertake flexion and extension movement of their joint whilst supporting their limb during the activity.

In another form the motion devices are a plurality of spaced apart rollers the are rotatably connected between the first and second wall portions along the generally arcuate path.

Each roller may include a central tubular portion that is rotatable around a shaft. The tubular portion may have a polyurethane or rubber coating to assist in engagement with a user's foot or footwear.

Opposing ends of the shaft extend outwardly from sides of the tubular portion and are configured to engage with respective cooperatingly shaped slots in the first or second wall portions.

A recessed, sealed, self-lubricating bearing is located at either end of the tubular portion to assist in rotation around the shaft.

In one form the length of the central tubular portion is between 12 cm and 16 cm and preferably 14.5 cm and the diameter is between 20 mm and 40 mm and preferably between 25 mm and 35 mm. The shaft may have a diameter of between 5 mm and 15 mm and preferably between 5 mm and 10 mm.

The shaft may extend outwardly from respective sides of the central tubular portion by between 10 mm and 15 mm and preferably 12.5 mm.

The first and second side walls may be generally parallel and are spaced apart by a distance of between 130 mm and 180 mm and preferably 150 mm.

The base may be generally rectangular with a width of between 130 mm and 200 mm and preferably 182 mm, and a length of between 600 mm and 1000 mm, and preferably 800 mm.

The first and second wall portions adjoin respective sides of the base and extend along the length thereof. The first and second wall portions may have a top that is parallel to and above the arcuate path delineated by the rotatably attached motion devices or the arcuate grooves, wherein the height of the first and second wall portions is between 40 mm and 80 mm at its lowered point, and between 270 mm and 320 mm at its highest point.

The top of the first and second wall portions and arcuate path may have a radius between 550 mm and 650 mm and preferably has a radius of 620 mm.

An end wall may adjoin sides of the first and second wall portions and an edge of the base. The end wall provides structural rigidity for the highest point of the first and second wall portions and assist in maintaining the distance therebetween.

The thickness of the end wall, first wall portion and second wall portion and base may be between 14 mm and 20 mm and preferably 16 mm.

The base, end wall, first side wall portion and second wall portion may be formed separately and connected together using fixing means such are screws, adhesive or brackets. Alternatively, the base, end wall, first wall portion and second wall portion may be of unitary construction and may be formed using injection or blow moulding techniques.

The arcuate path may take the form of the lower portion of an exponential curve, wherein the lower part of the arcuate path is flat and becomes progressively steeper towards the upper part of the arcuate path.

The rollers or bearings may be able to freely rotate as the foot is moved thereover, however an adjustable tensioning device may be used to increase the effort required by the user to move their foot thereover. Alternately, the rollers or bearings may be motorised such that they are driven to assist with movement of the limb thereover.

In another aspect of the invention there is proposed a method of undertaking an exercise or rehabilitation activity, including the steps of:

providing an apparatus including a housing that supports a plurality of spaced apart motion devices attached thereto to for an arcuate path or movable along the arcuate path;
positioning a user adjacent the housing;
positioning a part of a limb of the user onto at least some of the plurality of spaced apart motion devices or a platform positioned thereon or attached thereto; and moving the limb across or with the plurality of spaced apart motion devices, along the arcuate path to thereby undertake rehabilitation exercise of the limb or joint of the user.

In still another aspect of the invention there is proposed a method of undertaking a knee region exercise or rehabilitation activity, including the steps of: providing an apparatus including a housing that supports a plurality of spaced apart motion devices attached thereto to for an arcuate path or movable along the arcuate path;

positioning a user in a seated position adjacent a first end of the housing;
positioning a foot of the user onto at least some of the plurality of spaced apart motion devices or a platform positioned thereon or attached thereto, such that a lower portion of the adjoining leg of the user is at an angle between 70 degrees and 130 degrees to an adjoining upper portion of the user's leg;
moving the foot across or with the plurality of spaced apart motion devices, along the arcuate path to thereby undertake rehabilitation or exercise of the knee region.

The above method, wherein the foot is supported on the platform that is movable along the arcuate path, wherein the platform includes that motion devices attached thereto, the motion devices configured to engage an arcuate groove or grooves in the platform that delineate the arcuate path.

### BRIEF DESCRIPTION OF THE DRAWINGS

The accompanying drawings, which are incorporated in and constitute a part of this specification, illustrate an implementation of the invention and, together with the description and claims, serve to explain the advantages and principles of the invention. In the drawings,

FIG. 1 is a perspective of a first embodiment of the exercise and/or rehabilitation apparatus;

FIG. 2 is a side view of the apparatus of FIG. 1;

FIG. 3 is a cross-sectional view through A-A of the apparatus of FIG. 1;

FIG. 4 is the side cross-sectional view of FIG. 3, illustrating the foot of the user placed onto some of the rollers;

FIG. 5 is the side cross-sectional view of FIG. 4, illustrating the movement of the foot backwards and forwards between a partial extension position and a flexion position, about the axis of rotation of the knee;

FIG. 6 is the side cross-sectional view of FIG. 4, illustrating the movement of the foot into a full extension position;

FIG. 7 is the side cross-sectional view of FIG. 4, accommodating users having different leg lengths;

FIG. 8 is front view of one of the rollers of FIG. 1;

FIG. 9 is a side view of the roller of FIG. 8;

FIG. 10 is partial end view of the roller of FIG. 8;

FIG. 11 is a perspective view of a second embodiment of the exercise and/or rehabilitation apparatus, having an arcuate groove and platform assembly, engageable therewith;

FIG. 13 is an underside perspective view of the platform assembly of FIG. 11;

FIG. 14 is a side view of the platform assembly of FIG. 11;

FIG. 15 is a side cross-sectional view through B-B of FIG. 11, illustrating the foot resting on the platform having rollers that engage the arcuate groove;

FIG. 16 is the side cross-sectional view of FIG. 15, illustrating the movement of the platform and foot backwards and forwards between an extension position and a flexion position, about the axis of rotation of the knee;

FIG. 17 is the side cross-sectional view of FIG. 4, illustrating an alternate seating position of the user, wherein the upper leg is at an angle to the horizontal;

FIG. 18 is a perspective view of a third embodiment of the base portion of the exercise and/or rehabilitation apparatus;

FIG. 19 is a side schematic view of the base portion of the apparatus of FIG. 18;

FIG. 20 is a partial end view of the apparatus of FIG. 18 illustrating the angled groove;

FIG. 21 is an underside perspective view of a platform configured to engage the base of FIG. 18 having bearings removed;

FIG. 22 is an end view of the platform of FIG. 21;

FIG. 23 is an underside view of the platform of FIG. 21;

FIG. 24 is a side view of the platform of FIG. 21;

FIG. 25 is a top plan view of the platform of FIG. 21;

FIG. 26 is a front view of a bearing attachable to the platform of FIG. 21 and engageable with the angled groove of FIG. 20; and

FIG. 27 is a cross-sectional view through C-C of the bearing of FIG. 26.

### DETAILED DESCRIPTION OF THE ILLUSTRATED AND EXEMPLIFIED EMBODIMENTS

Similar reference characters indicate corresponding parts throughout the drawings. Dimensions of certain parts shown in the drawings may have been modified and/or exaggerated for the purposes of clarity or illustration.

Referring to the drawings for a more detailed description, there is illustrated a exercise and/or rehabilitation apparatus 10, demonstrating by way of examples, arrangements in which the principles of the present invention may be employed.

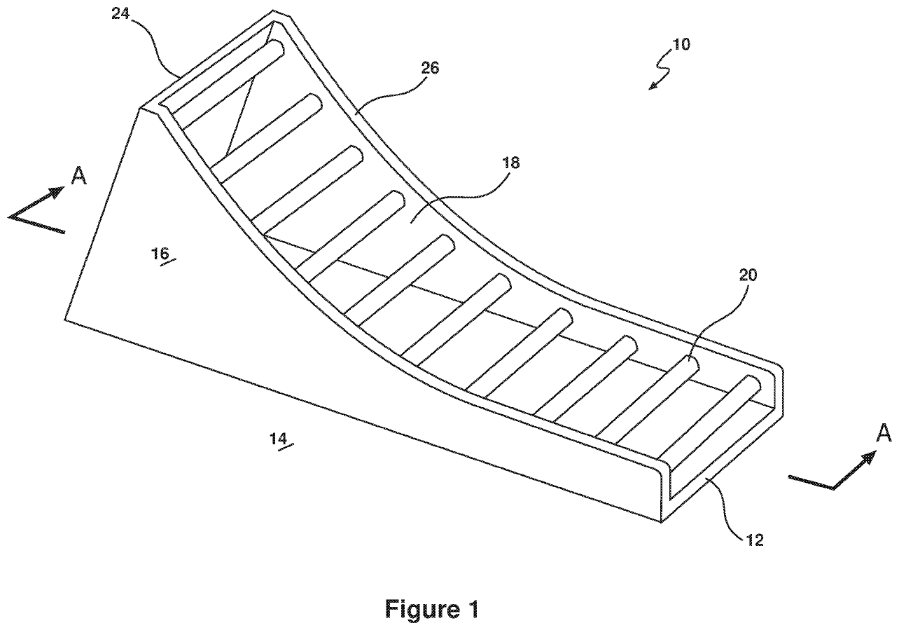

FIG. 1 illustrates one embodiment of the exercise and/or rehabilitation apparatus 10 comprising, a generally elongate base 12, supportable on a floor surface 14, a first wall portion 16 spaced apart from a second wall portion 18, both of which extend upwardly from the base 12, and a plurality of spaced apart motion devices 20, in the present embodiment being rollers. The rollers 20 are rotatably held intermediate of the first and second wall portions 16, 18, and form a generally arcuate path 22, as illustrated in FIG. 3. The exercise and/or rehabilitation apparatus 10 further include an end wall 24 that extends between edges of the first and second wall portions 16, 18 and adjoins the base 12.

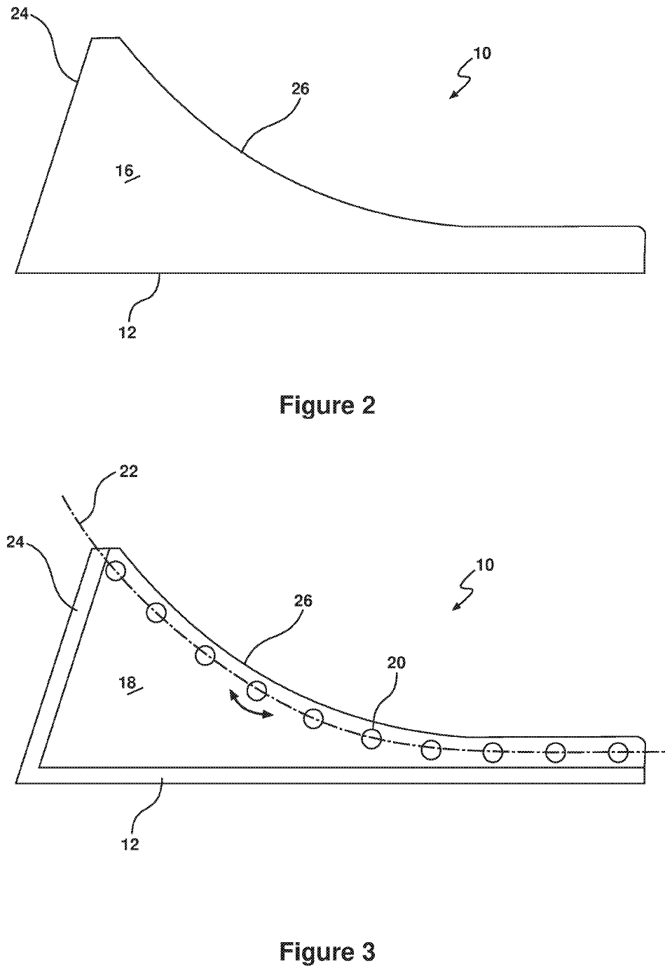

As illustrated in FIGS. 2 and 3, the upper edges 26 of the wall portions 16, 18 are curved and generally parallel with and above the arcuate path 22. As indicated in FIG. 3, each of the rollers 20 is able to rotate in both clockwise and anticlockwise directions, as the foot 28 is moved thereover.

The apparatus 10, will be discussed with reference to knee exercise and rehabilitation, however the reader should appreciate that the apparatus and a similar method can be used to exercise and rehabilitate other limbs and joints of the human body. For different applications the apparatus 10 may need to be placed on a raised surface when being used in relation to a user's arm, or may be positioned at an angle to the horizontal.

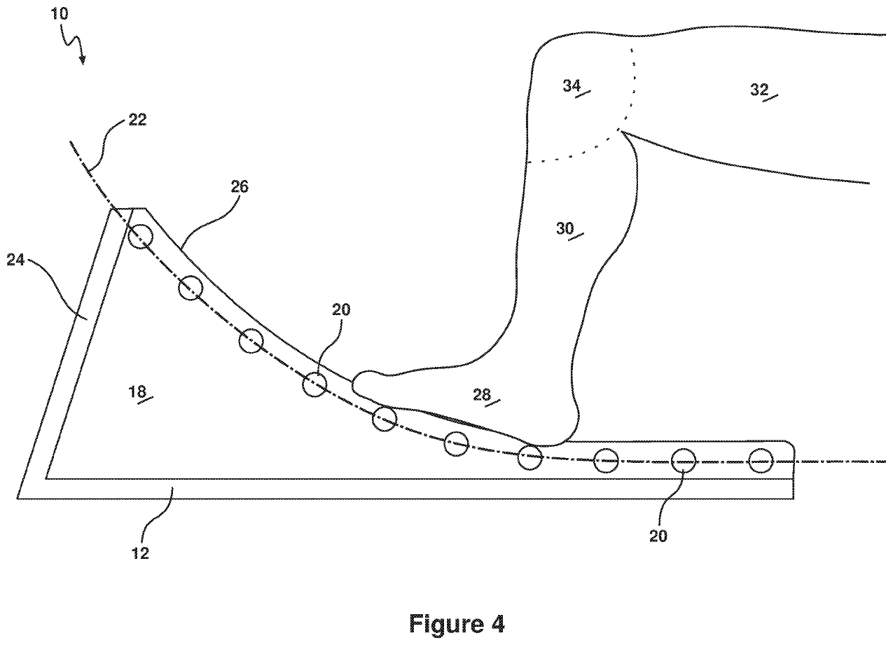

FIG. 4 illustrates the foot 28 of the user supported on at least some of the rollers 20 that delineate the arcuate path 22. As illustrated the lower leg 30 of the user, in the present example, is general perpendicular to the upper leg 32 of the user, wherein the knee region 34 is in a rest position, i.e. neither in the extension or flexion positions.

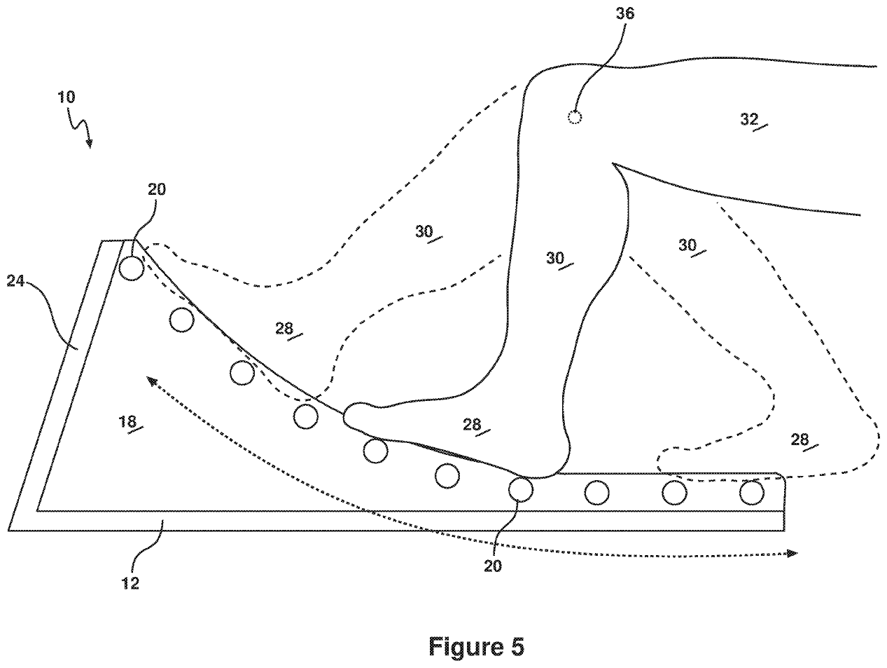

The user is then able to move their foot 28 backwards and forwards along the arcuate path 22, as indicated by the arrow in FIG. 5, to produce flexion and extension of the knee joint around the axis of rotation 36.

In the present embodiment, ten rollers 20 are positioned along the arcuate path 22 and are spaced apart at approximately 80 mm intervals. The reader should however appreciate that there may be more or less rollers and they may be spaced apart at a distance greater than or less than 80 mm.

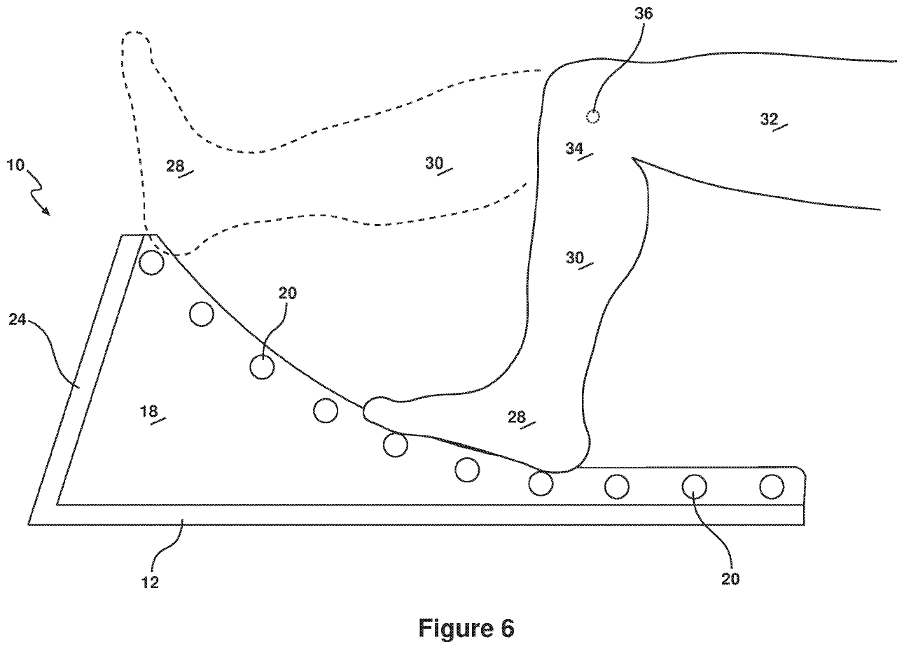

Furthermore, as illustrated in FIG. 6, the apparatus 10 can support the leg of the user when the knee is in a full extension position. The ability to progressively increase the movement of lower leg over time until the leg can be fully or almost fully extended, means that the apparatus 10 can be used by people recovering from knee replacement surgery to minimise the formation of scar tissue whilst reducing excessive pain.

Downward pressure onto the rollers will increase friction and therefore the user can easily modify the intensity of exercise. For instance, shortly after surgery a user can simply rest their foot on the rollers 20 and move their foot along the acuate path 22 with minimal friction. However, as the user recovers from surgery and wishes to work on their muscle tone, they can push down onto the rollers 20, as they move their foot along the acuate path 22, to increase friction and thereby the effort required.

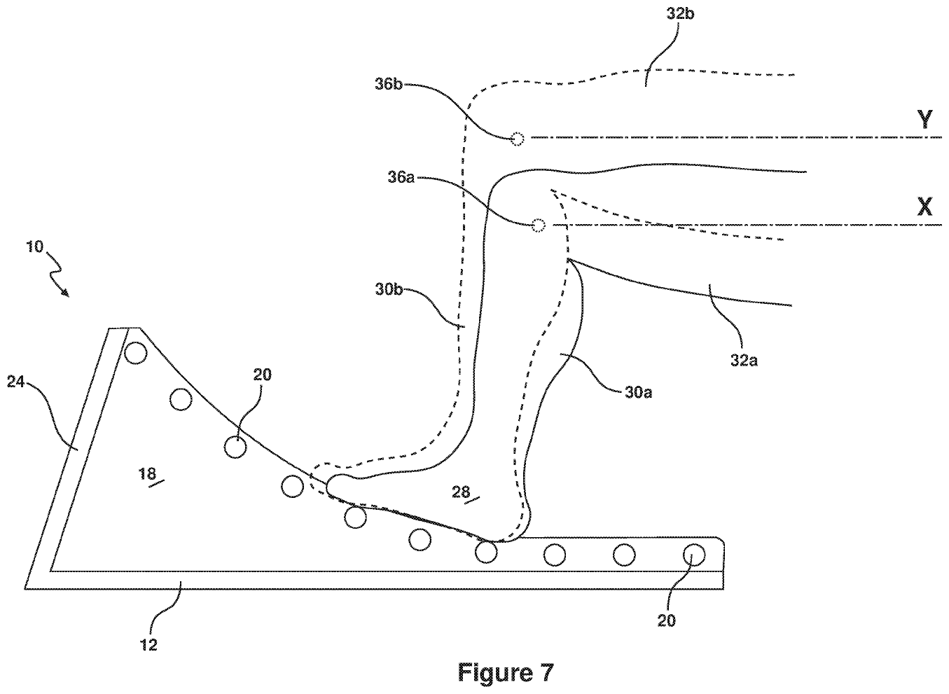

FIG. 7 illustrates use of the device for users having different leg lengths (30a, 32a compared to 30b, 32b). Where a user's leg is longer the axis of rotation 36b will be higher on a vertical axis, as indicated by Y, compared to the axis of rotation 36a of a user having shorter legs, as indicated by X. Nevertheless, the same apparatus 10 can be used and the taller user simply needs to sit slightly higher such that the upper and lower leg portions 30b, 32b, are at the desired angle.

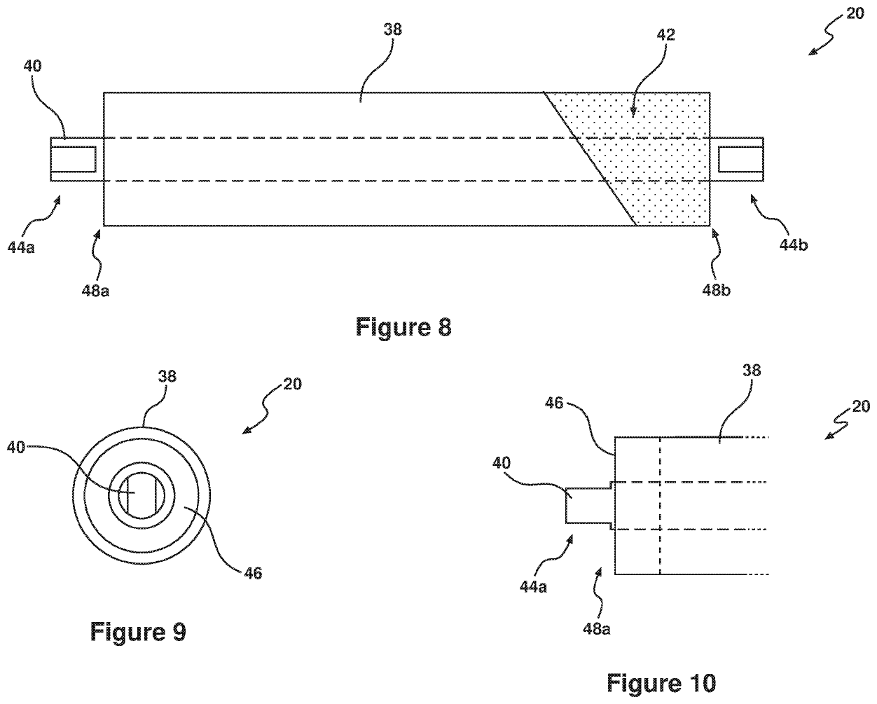

As illustrated in FIGS. 8 to 10, each roller 20 includes a central tubular portion 38 that is rotatable around a shaft 40. The tubular portion 38 has a polyurethane or rubber coating 42 to assist in engagement with a user's foot 28 or footwear (not shown).

Opposing ends 44a, 44b of the shaft 40 extend outwardly from sides of the tubular portion 38 and are configured to engage with respective cooperatingly shaped slots (not shown) in the inner side of the first or second wall portions 16 and 18. Recessed sealed, self-lubricating bearings 46 are located at either end 48a, 48b of the tubular portion to assist in rotation around the shaft 40.

FIG. 11 illustrates another embodiment of the exercise and/or rehabilitation apparatus 10 comprising, a generally elongate base 12, a first wall portion 16, spaced apart from a second wall portion 18, and both extending upwardly from the base 12, and an end spacer 50 that extends between the first and second wall portions 16, 18. The end spacer 50 can also be used as a handle for carrying the apparatus 10.

In the present embodiment, arcuate grooves or shoulders 52 are formed in inner sides of the first and second wall portions 16, 18. A platform assembly 54 is configured to engage with the arcuate grooves or shoulders 52 such that a user's foot can be rested thereon and moved along the arcuate path 22, along with the platform assembly 54.

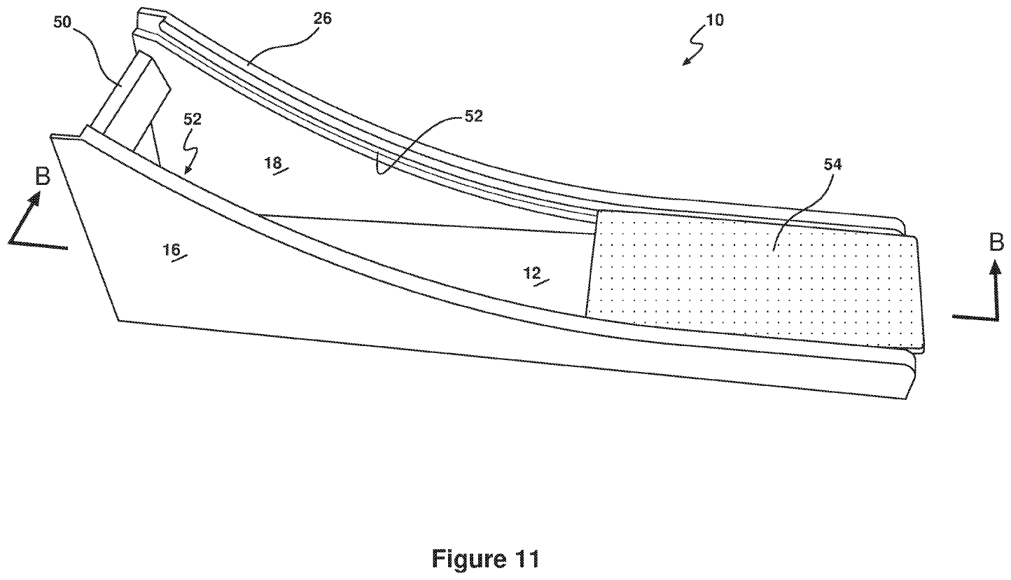

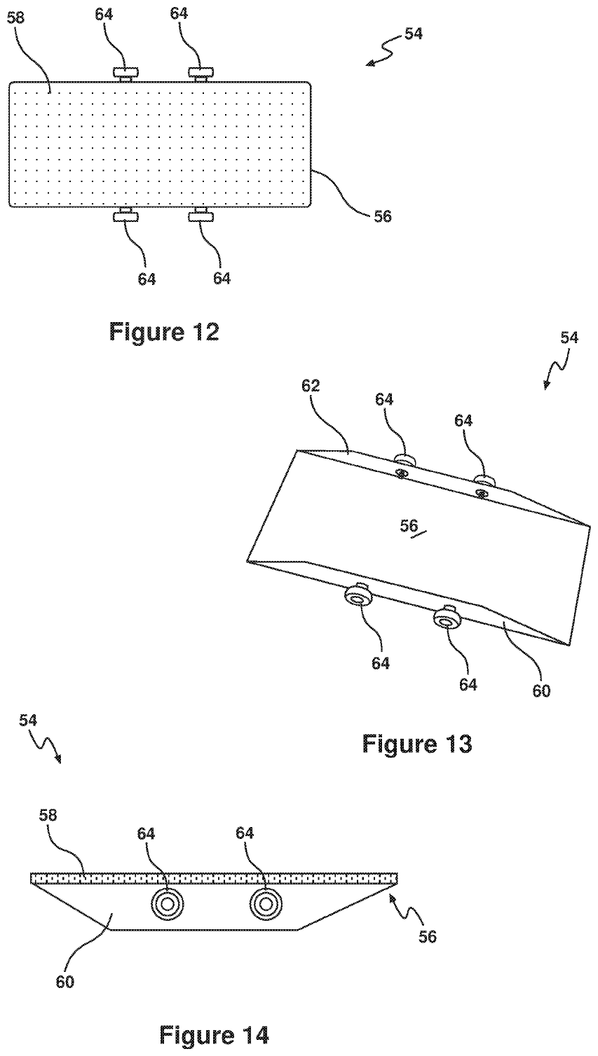

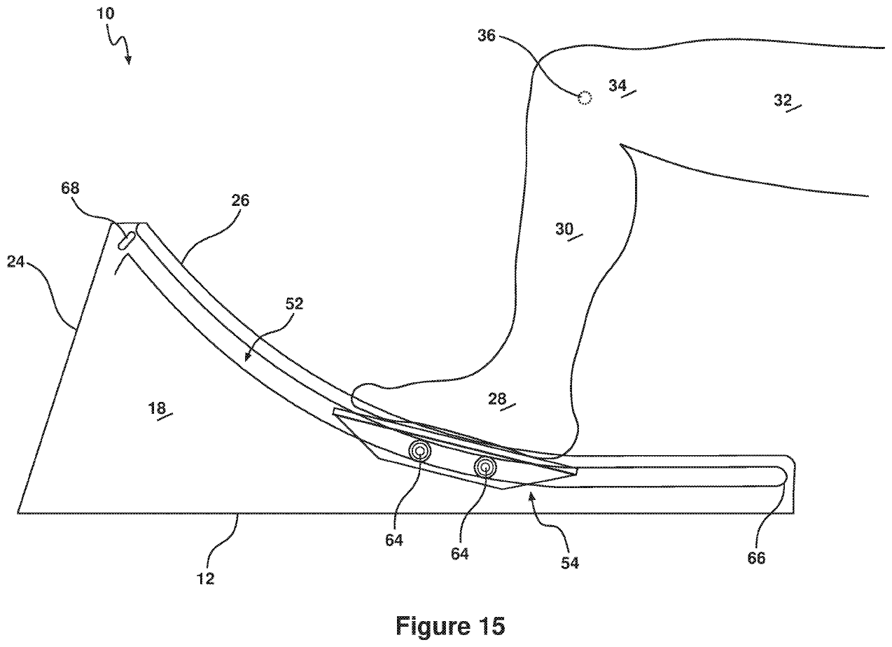

FIGS. 12 to 14 illustrate one possible embodiment of the platform assembly 54, including a generally planar platform body 56, a polyurethane or rubber grip surface 58, and depending flanges 60, 62 on opposite sides of the body 56. Each of the depending flanges 60, 62 includes two rollers 64 connected thereto and extending sidewardly therefore, such that the rollers 64 engage respective arcuate grooves 52 in a first or second wall portion 16, 18, as illustrated in FIG. 15.

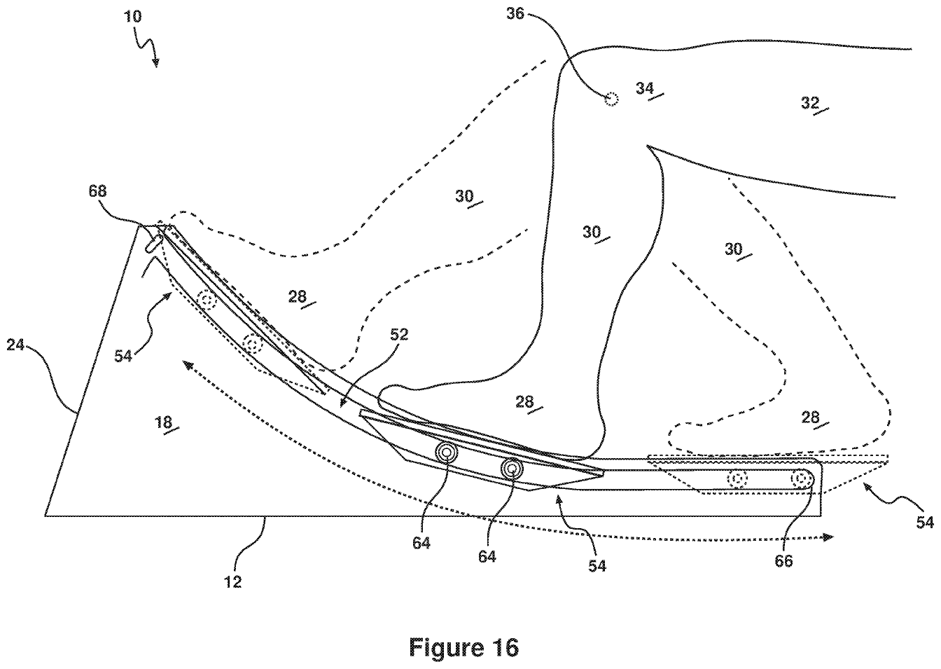

In this way the platform assembly 54 is movable backwards and forwards along the arcuate path 22 delineated by the grooves 52, as illustrated in FIG. 16, to permit the user to undertake knee rehabilitation exercise. As further illustrated in FIGS. 15 and 16, the grooves 52 are blind ended 66 at the lower end to prevent the platform assembly 54 disengaging from within the grooves 52 of first and second wall portions 16, 18. The upper end of the grooves 52 include detachable stops 68 that allow for removal of the platform assembly 54. This may be necessary to repair the rollers 64, or to replace the platform assembly 54 with a larger or smaller platform depending upon the size of the user's foot.

The reader should however appreciate that the platform assembly 54 may include sliders or bearings instead of rollers or the platform body 56 may be supported directly onto the plurality of spaced apart rollers 20, as previously illustrated in FIGS. 1 to 10, that are rotatably connected between the first and second wall portions 16, 18, along the generally arcuate path 22.

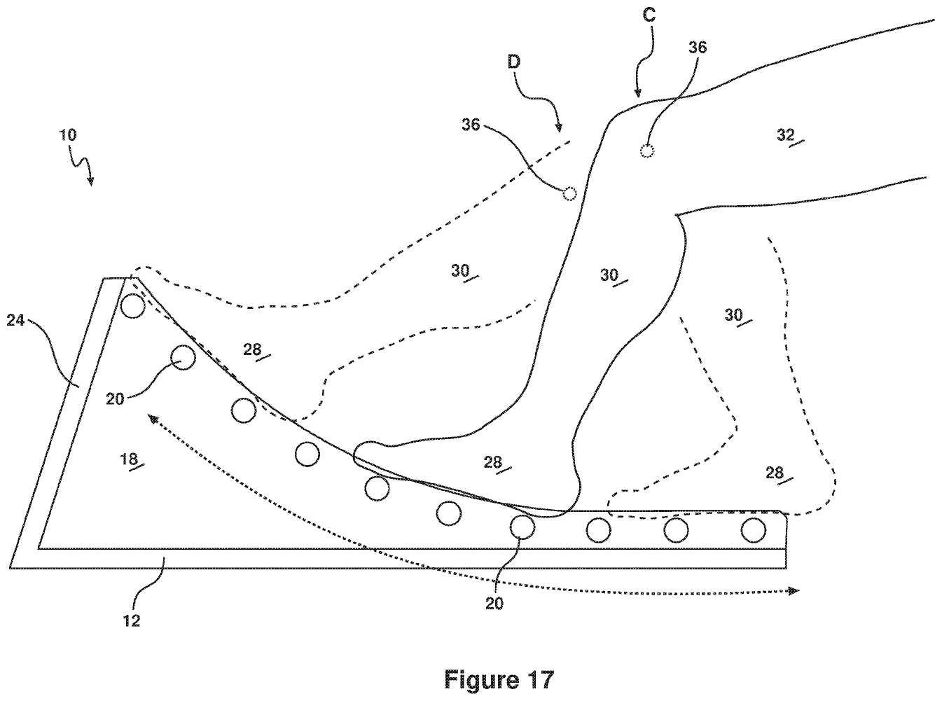

As further illustrated in FIG. 17, the seating position of the user may also be higher, such as being seated on a stool (not shown). This increases the angle between the lower leg 30 and the upper leg 32, such that as the foot 28 is moved forward, the axis of rotation 36 of the knee moved forward and downward from position C to position D, as the leg is extended. In this forward position the leg is generally straight when the foot is at the top of the apparatus 10. Although the foot 28 is not able to move backward as far as shown in FIG. 5, this rearward movement may be adequate for a patient's recovery from surgery.

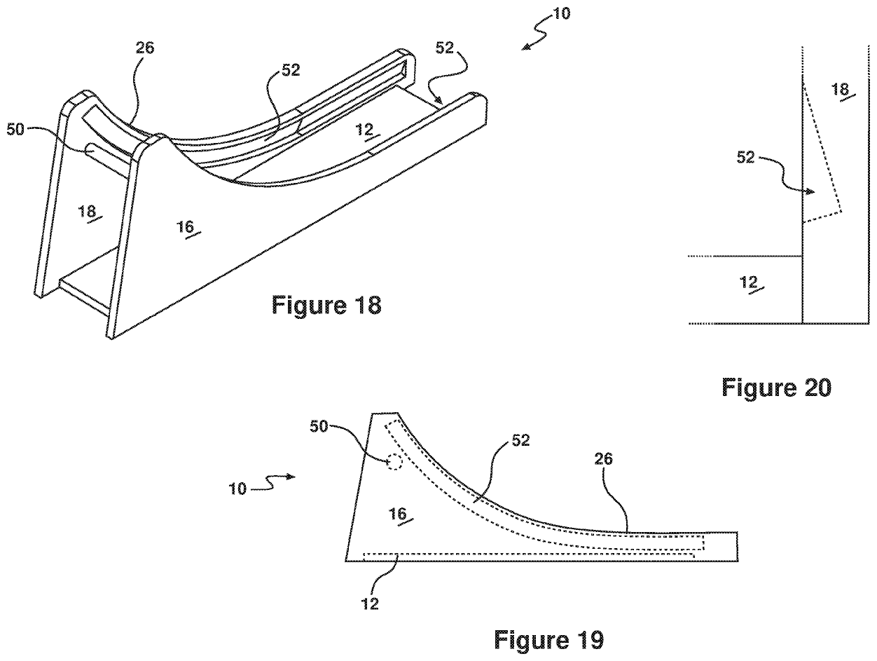

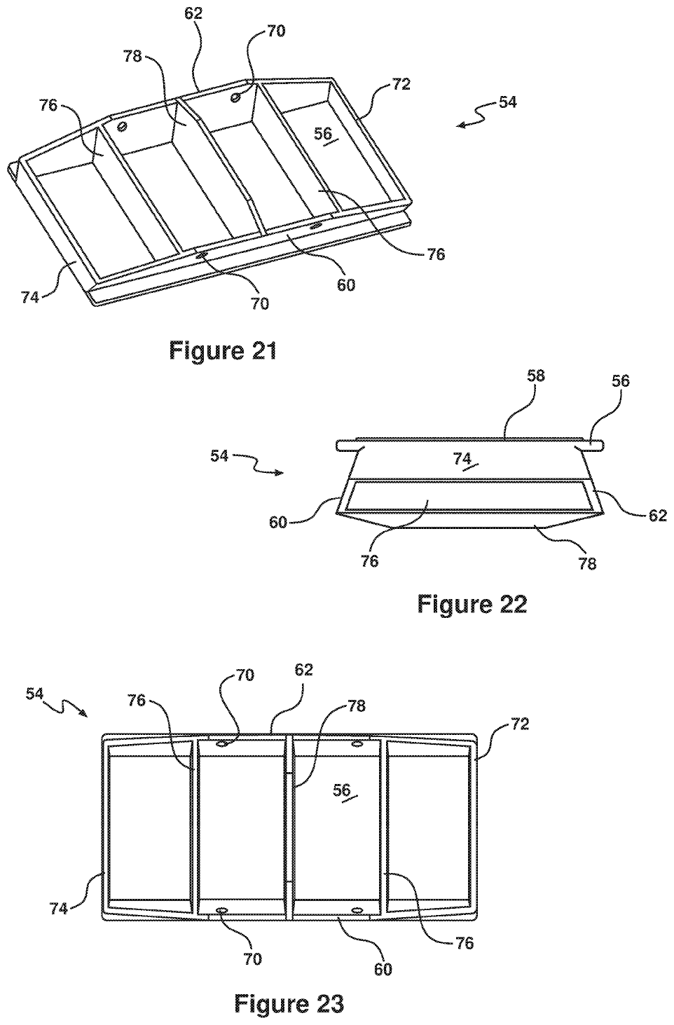

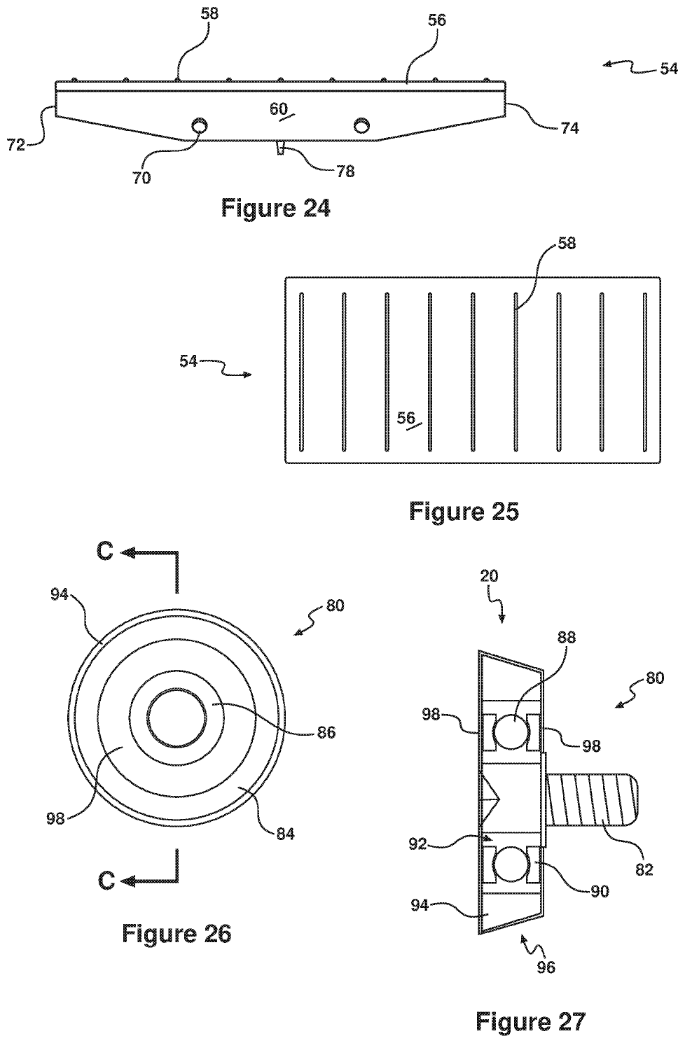

FIGS. 18 to 27, illustrates yet another embodiment of the apparatus 10, wherein the grooves 52 are angled, as best shown in FIG. 20. The platform 54, of the present embodiment includes the generally planar platform body 56 with polyurethane or rubber ridges that form the grip surface 58. The depending flanges 60, 62 on opposite sides of the body 56 are angled outwardly from the base 56, as best illustrated in FIG. 22, and includes apertures 70 for securing the motion devices 20 of FIGS. 26 and 27. The platform 54 further includes end portions 72, 74, and cross-members 76 and 78.

As illustrated in FIGS. 26 and 27 the motion device 20 includes a bearing 80 that is configured to engage the angled groove of FIG. 20. The motion device 20 is attached to the platform by way of screw 82, shown in FIG. 27, that engages aperture 70 in a flange 60 or 62. The bearing 80 includes an outer ring 84, an inner ring 86, a plurality of balls 88 held by separated 90, within ball race 92 and an outer polyurethane ring 94, which has an angled face 96. The bearing 80 further includes seals 98 on opposite sides as is known in the art. The bearing may be a 608 type bearing or similar.

The skilled address will appreciate that the base portion of the apparatus may be unitary in construction, and formed by injection moulding or blow moulding. Alternately, the base portion may be constructed from timber or other planar material that is held together using appropriate fixing means (not shown), such as screws or adhesive.

Similarly, the platform may be unitary in construction or may be constructed from separate parts held together with using appropriate fixing means (not shown), such as screws or adhesive.

The user can vary both their seating height and the position of the apparatus away from them, to thereby adjust the motion of the joint. Accordingly, the user can adjust the position of the apparatus and thereby the movement of their limb, to minimise pain or to target specific muscles in the limb. The apparatus can also be placed on a raised surface, such as a table, if being used to treat the arm of the patient.

The skilled addressee will now appreciate the advantages of the illustrated invention over the prior art. In one form the illustrated embodiment provides an apparatus for a user to undertake joint rehabilitation exercise at varying intensities depending upon their injury or stage of recovery from surgery, such as knee replacement surgery. Furthermore, the apparatus can be used for general exercise of the user's limbs and joints, to improve mobility or muscle tone, for instance for the elderly or patients in convalescence.

Various features of the invention have been particularly shown and described in connection with the exemplified embodiments of the invention, however it must be understood that these particular arrangements merely illustrate the invention and it is not limited thereto. Accordingly, the invention can include various modifications, which fall within the spirit and scope of the invention.

1. A limb or joint exercise and/or rehabilitation apparatus, comprising:
a generally elongate base;
a first wall portion extending upwardly from said base;
a second wall portion extending upwardly from said base, and spaced apart from said first wall portion;
an arcuate groove or shoulder in, or on, respective opposing inner sides of the first wall portion and the second wall portion, forming a generally arcuate path;
a platform for supporting a part of a user's limb thereon; and
at least two rollers, slide members or bearings attached or attachable to the platform and extending sidewardly therefore, such that said at least two rollers, slide members or bearings engage the respective arcuate grooves or shoulders in, or on, inner sides of the first wall portion and the second wall portion, wherein the platform is configured to follow the generally arcuate path to thereby permit the user to undertake exercise and/or rehabilitation activities of said limb or a joint thereof, by way of movement of the part of the user's limb along the arcuate path, thereby enabling flexion and extension of the joint of the user.

2. The apparatus in accordance with claim 1, wherein said apparatus is positionable on a floor surface whereby a user's foot is placeable on the platform, to thereby facilitate the undertaking of an exercise and/or rehabilitation activity of the leg, knee or hip.

3. The apparatus in accordance with claim 1, wherein the apparatus is positionable on a raised surface, whereby a user's hand or forearm is placed placeable on the platform, to thereby facilitate the undertaking of an exercise and/or rehabilitation activity of the arm, elbow, wrist or shoulder.

4. The apparatus in accordance with claim 2 for use in the exercise and/or rehabilitation of the muscles, tendons, joints and/or ligaments of the leg, knee, and/or ankle.

5. (canceled)

6. The apparatus in accordance with claim 1, wherein the platform comprises a generally planar body, having an upper surface including or comprising a grip surface, and depending flanges on or adjacent opposite sides of the body.

7. (canceled)

8. The apparatus in accordance with claim 6, wherein the depending flanges are at an angle relative to each other.

9. The apparatus in accordance with claim 8, wherein the arcuate grooves including a bearing surface at an angle to the plane of a respective first wall portion or second wall portion.

10. The apparatus in accordance with claim 9, wherein the at least two rollers, slide members or bearings include an angled face for engagement with the respective bearing surface of the angled arcuate groove or shoulder.

11. (canceled)

12. (canceled)

13. The apparatus in accordance with claim 1, wherein the arcuate path takes the general shape of a lower portion of an exponential curve, wherein the lower part of the arcuate path is generally flat and becomes progressively steeper towards the upper part of the arcuate path.

14. A method of undertaking an exercise or rehabilitation activity, including the steps of:
providing an apparatus in accordance with claim 1;
positioning a user adjacent the apparatus;
positioning a part of a limb of the user onto the platform; and
moving at least a part of the limb along the arcuate path to thereby undertake rehabilitation exercise of said limb or a joint of the user.

15. A method of undertaking a knee region exercise or rehabilitation activity, including the steps of:
providing an apparatus in accordance with claim 1;
positioning a user in a seated position adjacent a first end of the apparatus;
positioning a foot of the user onto the platform, such that a lower portion of the adjoining leg of the user is at an angle between 70 degrees and 130 degrees to an adjoining upper portion of the user's leg; and
moving the foot along the arcuate path to thereby undertake rehabilitation or exercise of the knee region of said user.

16. The apparatus in accordance with claim 3 for use in the exercise and/or rehabilitation of muscles, tendons, joints and/or ligaments of the wrist, elbow, and/or shoulder.
